(19) United States
(12) Patent Application Publication
(10) Pub. No.: US 2023/0003639 A1
(43) Pub. Date: Jan. 5, 2023

(54) Rope Ring with Wear Indicator

(71) Applicant: Sherrill, Inc., Greensboro, NC (US)

(72) Inventor: Cornelius McDaid, Randolph, MA (US)

(21) Appl. No.: 17/305,166

(22) Filed: Jul. 1, 2021

(51) Int. Cl. G01N 21/29; F16G 11/00

(52) U.S. Cl. CPC G01N 21/29; F16G 11/00

(57) ABSTRACT

A rope ring with a wear indicator. The typical ring is toroidal in shape. The wear indicator is a pair of opposed annular grooves in the side walls optionally spaced from the hole edge. As the ring wears, the hole diameter increases at points along either hole edge. In one method, maximum wear occurs when the hole wall edges form one or more indentations in either groove. In another method, maximum wear occurs when either groove is severed at one or more points on the groove. Optionally, the grooves are filled with a coloring agent to provide greater visibility to the wear indicator.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISK APPENDIX

Not Applicable

### BACKGROUND OF THE INVENTION

### 1. Field of the Invention

The present invention relates to tree rigging, more particularly, to rope ring.

### 2. Description of the Related Art

Although rope rings are made of hard materials, such as steel and aluminum alloys, friction between the ring and a rope passing through the ring causes the ring material to gradually wear away. As the material wears away, the ring becomes thinner and less able to handle the stresses it was designed to handle. Eventually, the ring will reach the point where it will fail.

Wear of a ring is currently determined by comparison or by measurement. One can visually compare the used ring to a new ring of the same type or measure the used ring to determine the amount of wear. However, without knowing how much wear is acceptable, these methods is not accurate.

### BRIEF SUMMARY OF THE INVENTION

The present invention is a rope ring with a wear indicator. The ring has a body with a perimeter that traces a simple closed curve about an axis, typically a circle, and a coaxial hole. The body has an outer wall, opposed side walls, and a hole wall. The outer wall extends around the outside of the body between the side walls. The side walls are generally flat and perpendicular to the axis. The hole wall curves inwardly from the side walls toward the axis. Typically, the curve is a circular and extending over approximately 125°.

The wear indicator is a pair of opposed, mirror-image, annular grooves in the side walls. Each groove is spaced from the hole edge. As the ring wears, the hole diameter increases at points along the circumference, causing those points on the edge of the hole to move outwardly toward the groove. There are two methods by which the groove can indicate maximum wear.

In the first method, maximum wear occurs when the hole wall edge forms an indentation in the groove. The only parameter affected is the groove spacing, which is set at under the maximum amount of wear by an amount that is visible to the naked eye.

In the second method, maximum wear occurs when the hole wall edge severs the groove at one or more points on the groove. The maximum amount of wear is the groove spacing plus the groove width.

Optionally, the groove is filled with a coloring agent to provide greater visibility to the wear indicator. The coloring agent is a material that will completely fill and be retained in the groove. Contemplated materials include enamel paint, epoxy paint, and plastic.

Objects of the present invention will become apparent in light of the following drawings and detailed description of the invention.

### BRIEF DESCRIPTION OF THE DRAWINGS

For a fuller understanding of the nature and object of the present invention, reference is made to the accompanying drawings, wherein:

FIG. 1 is a perspective view of a rope ring of the present invention;

FIG. 2 is a side view of the rope ring of the present invention;

FIG. 3 is a cross-sectional view of the rope ring taken at A-A;

FIG. 4 is a detailed view from the cross-section of FIG. 3;

FIG. 5 is a detailed view of one configuration of the wear indicator;

FIG. 6 is a partial side view of a configuration of the wear indicator with the ring showing wear;

FIG. 7 is a detailed view of another configuration of the wear indicator; and

FIG. 8 is a partial side view of another configuration of the wear indicator with the ring showing wear.

### DETAILED DESCRIPTION OF THE INVENTION

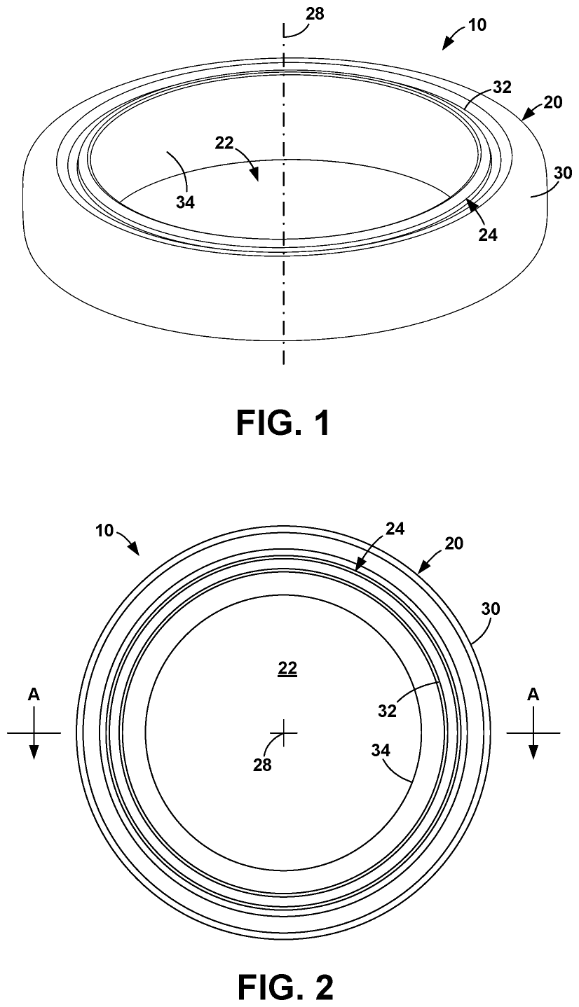

The present invention, shown in FIG. 1, is a rope ring 10 with a wear indicator 12.

The ring 10, shown in FIG. 2, has a body 20 with a perimeter that traces a simple closed curve, such as a circle, oval, ellipse, or D, about an axis 28. A hole 22 extends coaxially through the body 20. In the illustrated configuration, the body 20 is circular and the hole 22 is circular.

For the typical ring 10, the body 20 has a diameter 40 between 26 mm and 40 mm and a thickness 44 between 10 mm and 13 mm. The diameter 42 of the hole 22 is the body diameter 40 minus twice the thickness 44. The side-to-side dimension 46 of the body 20 is between 10 mm and 13 mm.

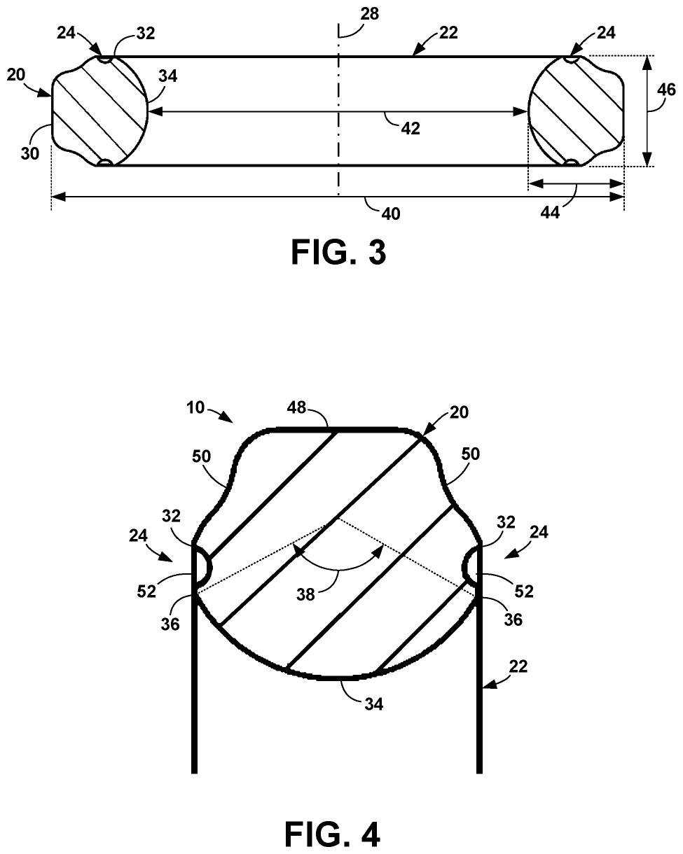

As shown in FIGS. 3 and 4, the body 20 has an outer wall 30, opposed side walls 32, and a hole wall 34.

The outer wall 30 extends around the outside of the body 20 between the side walls 32. The cross-sectional shape of the outer wall 30 is not important to the present invention. The shape can be round, oval, or another curve or combination thereof. In the configuration illustrated in FIG. 4, the outer wall 30 has a flattened distal surface 48 with a concavely curved surface 50 on each side of the distal surface 48 extending to the side walls 32.

The side walls 32 as illustrated are generally flat and perpendicular to the axis 28. The present invention contemplates that the side walls 32 do not have to be flat but can be curved.

As shown in FIGS. 3 and 4, the hole wall 34 curves inwardly from the side walls 32 toward the axis 28 of the hole 22 so as to eliminate any sharp edges that can damage a rope passing through the hole 22. Typically, the hole wall 34 is a circular curve extending over an arc 38 of approximately 110° to 190°, with the illustrated design being approximately 125°. However, the present invention contemplates any shape to the curve, such as parabolic, so that there are no sharp edges. Optionally, the hole wall 34 has a discontinuous edge 36 where the hole wall 34 meets the side wall 32.

The present invention contemplates that the ring 10 can be composed of any rigid, robust material. A non-exhaustive list of examples includes metal alloys such as steel and aluminum alloys, hard plastics, rubber, and carbon composites. A preferred material is 7075 aluminum alloy. A less robust material can be used if the ring 10 is designed to accommodate a lesser amount of stress.

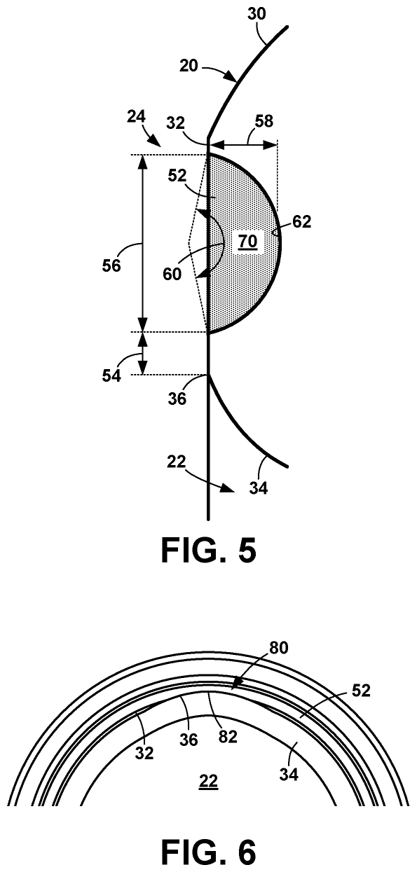

The wear indicator 24 includes a pair of opposed, mirror-image, annular grooves 52 in the side walls 32 of the body 20. As shown in FIG. 5, each groove 52 is optionally spaced a distance 54 from the hole edge 36, the groove spacing, as described below. The cross-section of the groove 52 is preferably, though not necessarily, curved. The curve is typically circular, as in FIG. 5, but can be another curved shape, such as parabolic or oval. The groove 52 in the current design has a width 56 in the range of from 0.5 mm to 2 mm. The actual width 56 depends on the particular application, as discussed below. The groove 52 extends over an arc 60 of up to 180°, with illustrated design being about 150°. The depth 58 of the groove 52 is in the range of from 0.5 mm to 2 mm. The depth 58 is only important in that the groove 52 needs to be deep enough to be visible.

As the ring 10 wears, the diameter 42 of the hole 22 increases in one or more points along the hole edges 36, causing those points on the edges 36 of the hole 22 to move outwardly toward the grooves 52. There are two methods by which the grooves 52 can indicate maximum wear. The method of wear indication being employed determines and position and parameters of the grooves 52.

In the first method of indicating maximum wear, maximum wear occurs when either of the hole wall edges 36 reaches into the corresponding groove 52, as at 80, and is indicated by an indentation 82 in the groove 52, as in FIG. 6. In other words, wear forms narrower sections of the groove 52, so the width 56 of the groove 52 is no longer constant around its circumference. The only parameter affected is the groove spacing 54, which is set at under the maximum amount of wear by an amount that is visible to the naked eye. For example, if the maximum amount of wear is 5 mm, the groove spacing 55 can be set at 4 mm so that, when a 1 mm indentation is visible, maximum wear has been reached. The larger the groove spacing 54, the more wear will occur before being visible on the groove 52.

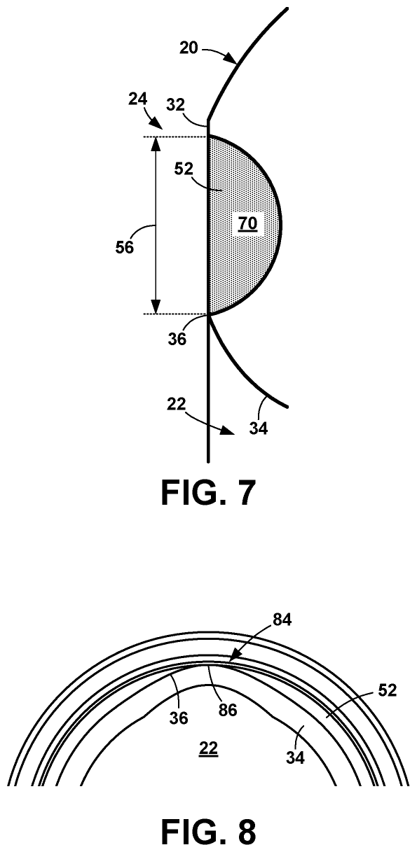

In the second method, maximum wear occurs when the one of the hole wall edges 36 passes completely across the corresponding groove 52 at one or more points 86 on the circumference, as at 84 in FIG. 8, so that the groove 52 no longer exists at the points 86. In other words, maximum wear is indicated when either groove 52 is severed at one or more points 86 on the circumference of the groove 52. Both the groove spacing 54 and groove width 56 are affected. The maximum amount of wear is the groove spacing 54 plus the groove width 56. The larger the groove spacing 54 and/or groove width 56, the more wear will occur before the groove 52 is severed. When using this method, it is contemplated that the groove spacing 54 can be as little as zero, as in FIG. 7, where the hole edge 36 is the edge of the groove 52.

Optionally, the grooves 52 are filled with a coloring agent 70. The coloring agent 70 gives greater visibility to the wear indicator 24. The coloring agent 70 is preferably of a color that contrasts with the color of the body 20 so that it is clearly visible when the ring 10 wears to the groove 52. An example color is red.

The coloring agent 70 is a material that will completely fill the groove 52 and be retained in the groove 52 without coming out during the life of the ring 10. Preferably, the color agent material will wear smoothly rather than crack or chip. Contemplated materials include enamel paint, epoxy paint, and plastic. A preferred material is alkyd gloss enamel. Optionally, the floor 62 of the groove 52 is textured to help retain the coloring agent 70.

Thus, it has been shown and described a rope ring with a wear indicator. Since certain changes may be made in the present disclosure without departing from the scope of the present invention, it is intended that all matter described in the foregoing specification and shown in the accompanying drawings be interpreted as illustrative and not in a limiting sense.

What is claimed is:

1. A rope ring comprising:
(a) a body having a perimeter tracing a simple closed curve about an axis, the body having a hole wall curved inwardly from a hole edge toward the axis defining a hole on the axis and a pair of opposed side walls, each separated from the hole wall by the hole edge; and
(b) a wear indicator comprising a wear groove in each side wall, each groove extending completely around the body.

2. The rope ring of claim 1 wherein the wear grooves are filled with a coloring agent.

3. The rope ring of claim 1 wherein maximum wear of the ring is indicated by either wear groove being severed.

4. The rope ring of claim 1 wherein maximum wear of the ring is indicated by a visible indentation in either wear groove.

5. The rope ring of claim 4 wherein each wear groove is spaced from the corresponding hole edge.

6. The rope ring of claim 1 wherein the body perimeter traces a circle and the hole is round.

7. The rope ring of claim 1 wherein the side walls are generally parallel to the axis.

8. A rope ring comprising:
(a) a body having a perimeter tracing a circle about an axis, the body having a hole wall curved inwardly from a hole edge toward the axis defining a round hole on the axis and a pair of opposed side walls, each separated from the hole wall by the hole edge; and
(b) a wear indicator comprising a wear groove in each side wall, each groove extending completely around the body and filled with a coloring agent.

9. The rope ring of claim 8 wherein maximum wear of the ring is indicated by either wear groove being severed.

10. The rope ring of claim 8 wherein each wear groove is spaced from the corresponding hole edge and maximum wear of the ring is indicated by a visible indentation in either wear groove.

11. The rope ring of claim 8 wherein the side walls are generally parallel to the axis.
